(19) United States
(12) Patent Application Publication
(10) Pub. No.: US 2010/0205183 A1
(43) Pub. Date: Aug. 12, 2010

(54) METHOD AND SYSTEM FOR PERFORMING SELECTIVE DECODING OF SEARCH RESULT MESSAGES

(75) Inventors: Scott Banachowski, Mountain View, CA (US); Swee Lim, Cupertino, CA (US); Ki Moon Kim, Cupertino, CA (US); Arun Kejariwal, Sunnyvale, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo!, Inc., a Delaware corporation, Sunnyvale, CA (US)

(21) Appl. No.: 12/370,278

(22) Filed: Feb. 12, 2009

(51) Int. Cl. G06F 17/30

(52) U.S. Cl. 707/748; 707/E17.017

(57) ABSTRACT

Methods and systems are provided that may be used to selectively decode results in messages received from child nodes for a particular search query.

### BACKGROUND

1. Field

The subject matter disclosed herein relates to a method and system for enhancing web search performance.

2. Information

The Internet/World Wide Web (WWW) has emerged as a widely used platform for various purposes such as, but not limited to, online shopping and online services. The increasing use of the Internet has in turn led to an exponential growth in the number of web pages, which has made searching for relevant information/product/service difficult. To this end, various search engines have been developed over the last decade.

A search engine may be utilized to search data characterizing a large number of web documents, such as websites. A search engine may perform millions of searches a day. A challenge in the design of a search engine is how to handle large volume of search queries (also referred to as load or traffic) while keeping latency for each search query to a minimum. One way to keep latency for a particular search at a minimum is to increase the capacity of a datacenter used in performing the search query. For example, additional processors/servers or other hardware may be implemented to handle searches. A drawback of increasing the capacity of a datacenter, however, is an increased cost of such additional hardware.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a diagram of a system for performing a document search according to one implementation.

FIG. 2 is a table of search results that may be generated by a child node after searching for a search query in a database according to one implementation.

FIG. 3 illustrates various tables of search results received from child nodes according to one implementation.

FIG. 4 is a flow diagram illustrating a process for performing a search query in a system having a plurality of child nodes according to one implementation.

FIG. 5 is a schematic diagram illustrating a computing environment system that may include one or more devices configurable to perform a search according to one implementation.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Some exemplary methods and systems are described herein that may be used to perform a search query. One or more master nodes may direct a combination of child nodes to search a particular universe of web documents, such as web pages. For example, one or more databases may include data or other information for a universe of known and previously examined web documents. A database may include information characterizing each web document based on factors such as, for example, key words or terms utilized in a particular web document, as well as images or titles used in a web document, to name just a few among many factors that may be considered in examining a categorizing a web document.

In one implementation, a database may be utilized to store information characterizing a known universe of web documents. Such a database may be distributed over several nodes. In one implementation, a plurality of child nodes may be utilized to search a database. When performing a search on a particular database, for example, an array, list, or table of search results may be obtained.

As used herein, an “array” or “list” of search results may include a plurality of web document identifiers (IDs) for a particular search query. An array may also include relevance scores for each web document.

Web documents corresponding to an array or list of results may be ranked according to relevance for a particular search query. In one example, an array or list of search results determined by a child node may include a table of items, with one search result listed on each row of the table. A highest ranked search result may be listed in the first row, a second-highest ranked search result listed in the second row, and so forth, up until a lowest ranked search result listed on the bottom row of the table. Accordingly, search results may therefore be listed in descending rank order. A table of search results may be encoded in a binary format, for example, and a particular entry may be “decoded” in order to be subsequently interpreted and/or presented to a user via a web page displaying results for a search query made via a search engine.

“Decoding” or “deserializing,” as used herein may refer to a process for converting at least a portion of a message into a format that may be utilized for subsequent processing. In one example, a message may include a table, where each row or line of the table is encoded in a binary format. In order to interpret a particular row, information, such as data, may be decoded from a binary format into another format that may be used in subsequent processing. Other types of encoding may alternatively be utilized. In one implementation, a serialization of data may allows a system to select from different encodings, some binary, and some textual (for example, Extensible Markup Language (XML) may be one of the supported text encodings).

A binary representation of results as encoded in a message, for example, may differ from a way in which such binary data is represented in memory because, in addition to containing raw data, such a message may be encoded with metadata to describe its contents. Such metadata may be used during a deserialization process to construct a data structure to be used by search algorithms. Such an in-memory data structure may have a rich Application Programming Interface (API), and so internally may be structured differently to support access by such an API. Such an in-memory data structure may, as a result, not be easily transferable as an object over a messaging protocol. Moreover, such an in-memory data structure may also be “expensive” to construct, where “expense” is in terms of computer resources, such as central processing unit (CPU), memory and thread synchronization required by a memory allocator, to name a few examples.

Such metadata makes a message self-describing (e.g., a message can be interpreted by a receiver without additional context). Such metadata provides an ability to pass such a rich in-memory representation from node-to-node, but may also require implementation of an efficient decoding/deserialization process, as discussed herein, to recover some costs involved in doing so.

A table may contain an encoded/serialized list of search results. A particular web document may be assigned a relevance score according to a comparison of characteristics of the web document relative to a search query. For example, use of certain key words, links, titles, or images in a web document may each affect a relevance score for a web document.

After a table of search results has been obtained by a child node, such a table may be sent back to a master node for subsequent processing. A child node may transmit a network message to a master node containing such a table of search results. In the event that, for example, many child nodes have searched one or more databases for the same search query, there may potentially be many tables of search results received by a master node. For example, if hundreds of child nodes are utilized, a master node may receive hundreds of tables of results for each search query.

Decoding every row of every table from all of the child nodes may potentially utilize a relatively large amount of processor capacity, increasing overall latency for a particular search query. Decoding every row may also require memory heap allocation, which in turn may cause synchronization delays (locks) on some multiprocessor systems, which may be an additional source of latency. In order to reduce such latency, one implementation may selectively decode items on various tables of search results received from child nodes. In one implementation, a set number of search results may be provided to a search engine as overall results for a particular search query. Such a set number of results may be smaller, and in some cases., smaller by one or more orders of magnitude, than a total number of search results listed in each received table of search results from various child nodes.

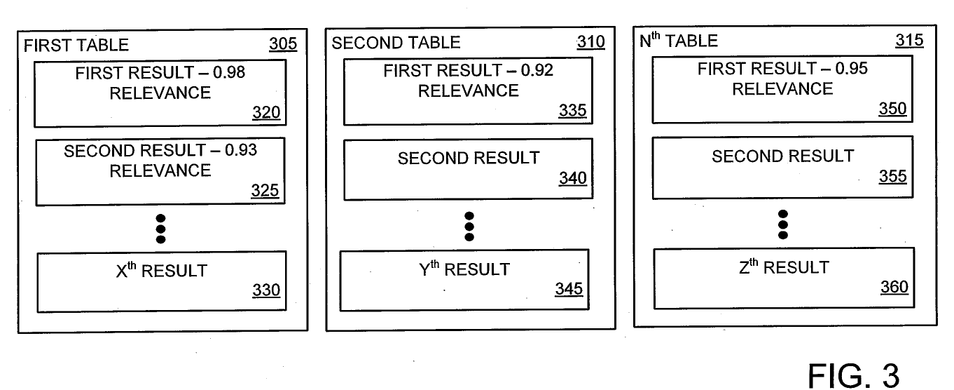

Because a first line of each table of search results may contain the most relevant web document for a particular search query, only the first line of each table may initially be decoded. As discussed below with respect to FIG. 3, a result with the highest relevance score may be extracted and added to a master table of search results, and the next item from the table of search results in which the most relevant item was found may subsequently be decoded. Next, the next-most relevant item of the remaining items in the tables of search results is determined and then added to the master table of search results. The next line in the table from which the second most relevant item was determined in subsequently decoded. This process may continue until a master table has been filled with a set number of search results. When a master table is completely determined, it may be forwarded in a message to a processing device for subsequent processing.

Decoding of items in tables of results received from child nodes may be limiting factors in handling a higher load. This is due to a large number of string operations which are computationally expensive—in one example, string operations may account for coverage, defined as the percentage of run time, of over 35% on a master node. This may necessitate an optimization of a decoding process on the master node. Such a process, as described herein, may provide an efficient method for determining a master list of search results for a search query in which only the most relevant items are decoded, and the less relevant items may not even be decoded at all.

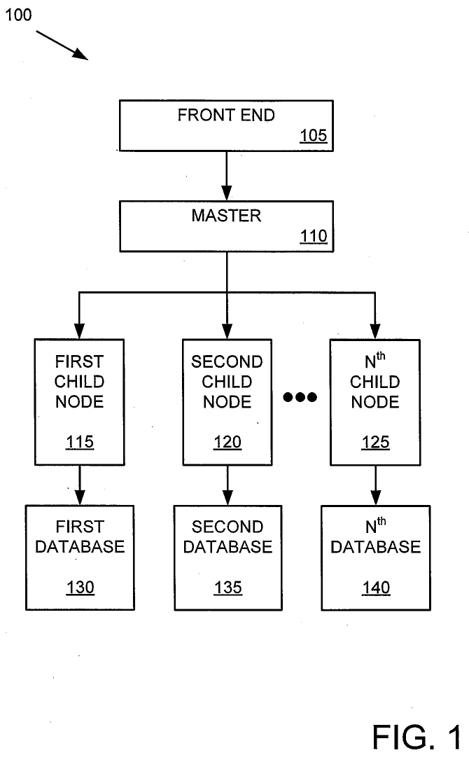

FIG. 1 is a diagram of a system 100 for performing a document search according to one implementation. In this example, system 100 may be utilized to perform an Internet-based web search of web documents. In this example, a user may visit an Internet search engine via a web browser and may provide a search query to the search engine. A user's search query may be provided to a front end 105 from a search engine. Front end 105 may format a search query into a set of instructions which may be forwarded to master 110. Master 110 may be adapted to communicate such search query instructions to a set of child nodes, such as first child node 115, second child node 120, and additional child nodes up until Nth child node 125. Each child node may be adapted to search one or more databases, sub-databases, or partitions of databases. Each database may contain information characterizing web documents in a known and previously examined universe or corpus of web documents. In this example, first child node 115 may search for a search query in first database 130, second child node 120 may search for a search query in second database 135, and Nth child node 125 may search for a search query in Nth database 140. A child node may comprise, for example, a server or other electronic device capable of performing a search. In one implementation, each child node may comprise a separate hardware device or computing apparatus. In another implementation, a single hardware device may comprise more than one child node. In one implementation, one or more child nodes may be implemented via a software module.

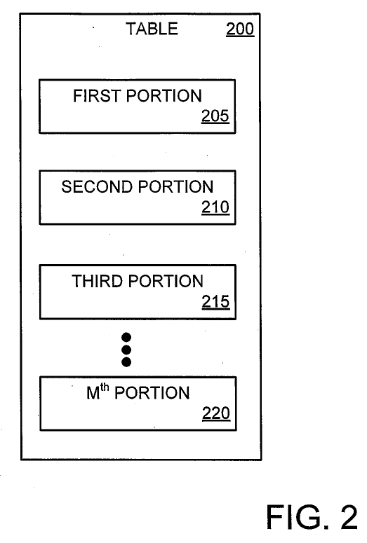

After performing a search, search results may be ranked in relevance order and assimilated in an array or table by each respective child node. FIG. 2 is a table 200 of search results that may be generated by a child node after searching for a search query in a database. In this example, table 200 includes results from a search query presented in several portions, such as a first portion 205, second portion 210, third portion 215, and additional portions up until Mth portion 220. Each respective portion of table 200 may comprise a different row or line of table 200. First portion 205 may comprise a link to a web document, such as a website Uniform Resource Locator (URL), a relevance score for a search query, and/or additional information such as hashes used to remove duplicate (dedup) documents by different criteria, flags indicating a type of document (e.g., adult content), language of the document, inputs that were used to calculate a relevance score of a document, a date on which a document was last crawled, to name a few among many items of information that may be returned.

As discussed above, results in table 200 may be ranked in a relevance order, with a web document result with the highest relevance being ranked first, in first portion 205, and a web document with a lowest relevance being ranked last, in Mth portion 220, in this example. Information contained in a portion, such as first portion 205, may be encoded in a binary format or in some other format. In order to determine information contained in a portion, any information encoded in a format may be selectively decoded.

Table 200 may be sent to master 110 via an encoded network message. An encoded message containing table 200, for example, may be formed in a self-describing format, meaning that in addition to the raw data, the message contains information about how to interpret the data (e.g., a schema is encoded with the data). To decode a message, an encoded/serialized message or array may be parsed from beginning to end to read both schema and data, to recreate the original data structure. Master node 110 may decode responses from child nodes in order to merge such responses to obtain an overall sorted list of responses and select the top.

A technique described herein, “selective decoding,” “selective deserialization,” or “lazy deserialization,” may optimize processing of responses from child nodes by decoding each response in a demand-driven fashion. Intuitively, lines or items in tables received from child nodes may be decoded until enough matching documents are found to satisfy a predefined threshold, instead of decoding all lines or items of all tables received from child nodes. For example, results may be managed in blocks of size 100 documents. To ensure that enough documents are found to satisfy this request, each child node may return at least 100 documents. In practice, a cluster of 100 children nodes may result in the master receiving 10,000 documents, from which it must narrow the results down to the top 100. Child responses only need to be decoded until enough (e.g., 100) matching documents are found.

FIG. 3 illustrates various tables of search results received from child nodes according to one implementation. In this example, a first table 305, second table 310, and so on, up until an Nth table 315 may be received by a master node, such as master 110 shown in FIG. 1. Each table may include a plurality of results received for a particular search query. In this example, first table 305 may include a first row or section 320, a second row 325, and so on, up through an Xth row 330. A row may include a web document ID and a relevance score, among other information, and each row may include at least some data or information which is encoded. In this example, upon being received by a master 110, first row 320 may be decoded to determine a first result and a relevance score. In this example, a first result in first table 305 has a relevance score of 0.98.

Similarly, second table 310 may include a first row or section 335, a second row 340, and so on, up through a Yth row 345. In this example, upon being received by a master 110, first row 335 may be decoded to determine a first result and a relevance score. In this example, a first result in second table 310 has a relevance score of 0.92.

Third table 315 may include a first row or section 350, a second row 355, and so on, up through a Zth row 360. In this example, upon being received by a master 110, first row 350 may be decoded to determine a first result and a relevance score. In this example, a first result in third table 310 has a relevance score of 0.95.

After a first row or section in each table received from various child nodes has been decoded, a result having the highest relevance is removed from its table and added to a master table. In this example, first result in first row 320 of first table 305 has the highest relevance score of 0.98. Accordingly, this result is added to a master table as the top overall result for a particular search query. Next, the next row or section is decoded from a table from which the most relevant web document was obtained. In this example, second result of second row 325 of first table 305 is decoded to reveal a second result and a relevance of 0.93.

Next, a result having the highest remaining relevance is added to a master table. In this example, a remaining result having the highest relevance score in first result in first row 350 of Nth table 315, which has a relevance score of 0.95. Accordingly, first result of Nth table 315 is removed from Nth table 315 and added to a master table. If the master table is not yet full, second row 355 of Nth table 315 may subsequently be decoded. This process may continue until a master table has been filled with a predetermined set number of search results. Such a master table may be sent to a front end, such as front end 105 shown in FIG. 1 for subsequent processing and eventual presentation to a user of a search engine.

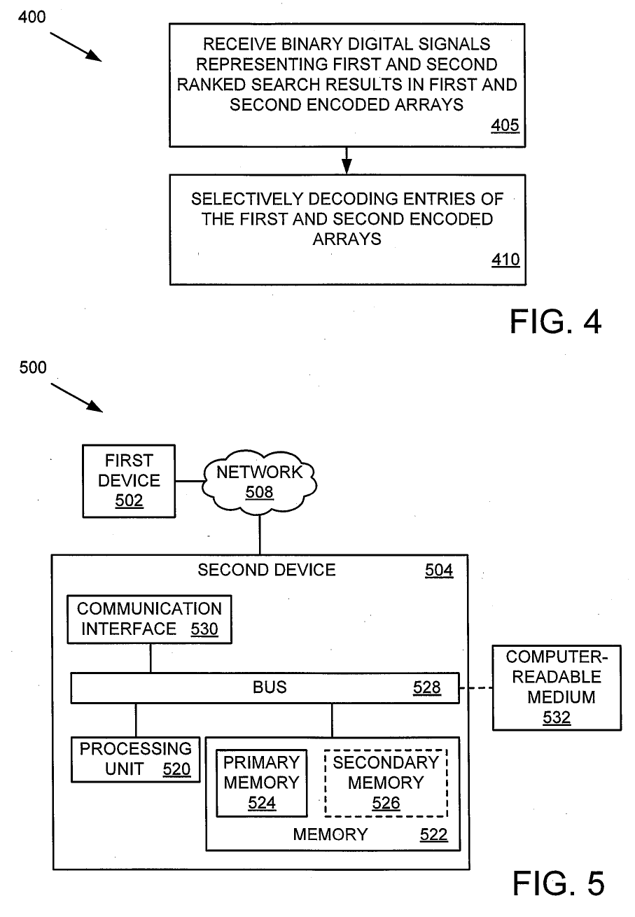

FIG. 4 is a flow diagram illustrating a process 400 for performing a search query in a system having a plurality of child nodes. First, at operation 405, binary digital signals may be received from a communications network. Such binary digital signals may represent first and second ranked search results obtained in response to a search query, and may be formatted into corresponding first and second arrays. Next, at operation 410, entries of the first and second arrays may be selected and decoded in descending rank order to provide a set number of combined ranked search results, as discussed above with respect to FIG. 3. Such decoded entries may be added to a master array or table which may be sent to a front end for further processing.

FIG. 5 is a schematic diagram illustrating a computing environment system 500 that may include one or more devices configurable to perform a search using one or more techniques illustrated above, for example, according to one implementation. System 500 may include, for example, a first device 502 and a second device 504, which may be operatively coupled together through a network 508.

First device 502 and second device 504, as shown in FIG. 5, may be representative of any device, appliance or machine that may be configurable to exchange data over network 508. First device 502 may be adapted to receive a user input from a program developer, for example. By way of example but not limitation, either of first device 502 or second device 504 may include: one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

Similarly, network 508, as shown in FIG. 5, is representative of one or more communication links, processes, and/or resources configurable to support the exchange of data between first device 502 and second device 504. By way of example but not limitation, network 508 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

It is recognized that all or part of the various devices and networks shown in system 500, and the processes and methods as further described herein, may be implemented using or otherwise include hardware, firmware, software, or any combination thereof.

Thus, by way of example but not limitation, second device 504 may include at least one processing unit 520 that is operatively coupled to a memory 522 through a bus 528.

Processing unit 520 is representative of one or more circuits configurable to perform at least a portion of a data computing procedure or process. By way of example but not limitation, processing unit 520 may include one or more processors, controllers, microprocessors, microcontrollers, application specific integrated circuits, digital signal processors, programmable logic devices, field programmable gate arrays, and the like, or any combination thereof.

Memory 522 is representative of any data storage mechanism. Memory 522 may include, for example, a primary memory 524 and/or a secondary memory 526. Primary memory 524 may include, for example, a random access memory, read only memory, etc. While illustrated in this example as being separate from processing unit 520, it should be understood that all or part of primary memory 524 may be provided within or otherwise co-located/coupled with processing unit 520.

Secondary memory 526 may include, for example, the same or similar type of memory as primary memory and/or one or more data storage devices or systems, such as, for example, a disk drive, an optical disc drive, a tape drive, a solid state memory drive, etc. In certain implementations, secondary memory 526 may be operatively receptive of, or otherwise configurable to couple to, a computer-readable medium 532. Computer-readable medium 532 may include, for example, any medium that can carry and/or make accessible data, code and/or instructions for one or more of the devices in system 500.

Second device 504 may include, for example, a communication interface 530 that provides for or otherwise supports the operative coupling of second device 504 to at least network 508. By way of example but not limitation, communication interface 530 may include a network interface device or card, a modem, a router, a switch, a transceiver, and the like.

System 500 may utilize second device 504 to implement an application program to analyze an image to determine whether such an image contains spam.

A technique discussed herein may optimize processing of responses from child nodes. Selective decoding may reduce a number of string operations—a potentially dominant component of overall query latency at the master node—significantly. This in turn may facilitate handling of higher levels of load, e.g., by 30% in one implementation at the same central processing unit (CPU) utilization level.

Selective decoding, as discussed herein, may be implemented at an application level such that no new hardware enhancements are required. Selective decoding may optimize processing of child node responses at a master node 100 without impacting the latency and the overall relevance. Selective decoding may exploit a fact that only a subset of all search results returned by child nodes are selected and sent to the front end as a final list of search results for a particular search query.

In one implementation, a search result message sent from a child node to a master may contain two primary sections. A first section may include general information about search results (e.g., a number of results and/or a count of documents found for each search term). A second section may include a table describing such documents. Each line, section, or row of a table may represent a document, and columns of a table may represent information requested about a document (e.g., its unique identifier (ID), a relevance score, and/or a ranking within all search results obtained by a child node).

In one implementation, a search result message may contain more than two sections, and there may be multiple tables per message that must each be selectively decoded or deserialized. Messages may be encoded so that each table may be broken out and selectively decoded independently. Such selective encoding may be accomplished by using recursion, e.g., by nesting each simple message (e.g., a two or more section message as described) as elements of a containing message. Decoding or deserialization may also occur recursively, but by decoding a container message into multiple simpler messages, and then applying the same technique again to such messages.

Data from child nodes to a master node may be sent in a self-describing, serial format. “Self-describing” may indicate that in addition to data itself, a message may include a schema that describes data encoded in the message. Decoding of a message may consist of decoding such schema to reconstruct data as a child node sent it. This may enforce a stream-oriented approach (strictly serial) to parsing data, because the interpretation of the data required by the decoder depends on a schema of data that appears before it. A schema may contain a name (string) and type information about all data elements and data elements may themselves be strings. Hence decoding may induce much string processing.

Data in a first section of a message from a child node may appear in an encoded format before a second section of the message in which a table of search results in included. A section may be represented in an encoded form as a table, row-by-row, with rows sorted by rank. When a message from a child node is received by a master, the master may parse only a first section of the message and pause before parsing a second section. Following this step for each child node, it may merge documents in all of the messages received from various child nodes in a communications network. Because the document data is represented row-by-row, already sorted, using the merge-sort algorithm can produce the top N documents over all children without requiring the full tables encoded in each message to be parsed. Because the message contains no data after the table, when enough documents are found to satisfy the request, the unparsed remainder of messages may be discarded without any data loss.

A selective decoding technique, as discussed herein, may reduce overall coverage of string operations. Additionally, a higher load may be handled at a master node without impacting latency and without requiring any additional hardware.

A selective decoding technique may provide several advantages. First, a higher load may be handled for the same capacity or in other words, for a particular hardware configuration. An ability to handle a higher load may improve a key bottom line item, such as $/search query, e.g., enabling processing of larger number of search queries per dollar of investment. Second, for the same load, a reduction in CPU utilization may enable use of advanced document ranking algorithms which may not typically be deployed as a result of their computational intensive nature. Gains with respect to CPU utilization may be much higher as a number of child nodes increases.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method comprising:
executing instructions on a specific apparatus so that:
binary digital signals received from a communications network and representing first and second ranked search results obtained in response to a search query are formatted into corresponding first and second arrays; and
entries of said first and second arrays are selected and decoded in descending rank order to provide a set number of combined ranked search results.

2. The method of claim 1, wherein the descending rank order is based, at least in part, on a relevance score.

3. The method of claim 1, further providing the set number of combined ranked search results to a search engine.

4. The method of claim 1, wherein the first array is received from a child node adapted to perform a search based on the search query within a first database of data corresponding to one or more web documents.

5. The method of claim 4, wherein the second array is received from at least a second child node adapted to perform the search based on the search query within at least a second database of data corresponding to one or more additional web documents.

6. The method of claim 1, wherein at least one of the first array or the second array comprise a message in a self-describing format.

7. An apparatus comprising:
a specific apparatus adapted to:
obtain first and second arrays comprising first and second ranked search results, said first and second ranked search results being provided in response to a search query, from binary digital signals representing said first and second ranked search results received from a communications network; and
select and decode entries of said first and second arrays in descending rank order to provide a set number of combined ranked search results.

8. The apparatus of claim 7, wherein the specific apparatus is further adapted to rank the list of the set number of combined ranked search results based, at least in part, on a relevance score.

9. The apparatus of claim 7, wherein the specific apparatus is further adapted to provide the set number of combined ranked search results to a search engine.

10. The apparatus of claim 7, wherein the specific apparatus is further adapted to receive the first array from a child node adapted to perform a search based on the search query within a first database of data corresponding to one or more web documents.

11. The apparatus of claim 10, wherein the specific apparatus is further adapted to receive the second array from a second child node adapted to perform the search based on the search query within at least a second database of data corresponding to one or more additional web documents.

12. The apparatus of claim 7, wherein at least one of the first array or the second array comprises a message in a self-describing format.

13. An article comprising:
a storage medium comprising machine readable instructions stored thereon which, if executed by a specific apparatus, are adapted to direct said specific apparatus to:
obtain first and second arrays comprising first and second ranked search results, said first and second ranked search results being provided in response to a search query, from binary digital signals representing said first and second ranked search results received from a communications network; and
select and decode entries of said first and second arrays in descending rank order to provide a set number of combined ranked search results.

14. The article of claim 13, wherein the machine readable instructions, if executed by the specific apparatus, are adapted to enable the specific apparatus to rank the list of the predetermined number of relevant search results based, at least in part, on a relevance score.

15. The article of claim 13, wherein the machine readable instructions, if executed by the specific apparatus, are adapted to enable the specific apparatus to provide the predetermined list of the predetermined number of relevant search results to a search engine.

16. The article of claim 13, wherein the machine readable instructions, if executed by the specific apparatus, are adapted to enable the specific apparatus to receive the first array from a child node adapted to perform a search based on the search query within a first database of data corresponding to one or more web documents.

17. The article of claim 16, wherein the machine readable instructions, if executed by the specific apparatus, are adapted to enable the specific apparatus to receive the second array from a second child node adapted to perform the search based on the search query within at least a second database of data corresponding to one or more additional web documents.

18. The article of claim 13, wherein the first message and the at least a second message comprise a message in a self-describing format.
